(19) United States
(12) Patent Application Publication
(10) Pub. No.: US 2012/0274622 A1
(43) Pub. Date: Nov. 1, 2012

(54) ORGANIC LIGHT EMITTING DIODE PIXEL CIRCUIT

(75) Inventors: Hyley H. Huang, Hsinchu City (TW); Wen-Chun Wang, Taichung City (TW); Wen-Tui Liao, Taichung City (TW); Tsung-Yu Wang, Taichung City (TW); Chih-Hung Huang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/458,295

(22) Filed: Apr. 27, 2012

(30) Foreign Application Priority Data
Apr. 29, 2011 (TW) 100115256
Jun. 20, 2011 (TW) 100121494

(51) Int. Cl. G09G 3/30; G06F 3/038

(52) U.S. Cl. 345/212; 345/76

(57) ABSTRACT

An organic light emitting diode (OLED) pixel circuit includes a driving node, a pixel driving unit, an electroluminescent device, and a compensation unit. The pixel driving unit is coupled to a data line receiving a data voltage and provides a driving voltage to the driving node. The display electroluminescent device is coupled to the driving node for illuminating in response to the driving voltage, wherein the level of the driving voltage is related to an aging factor voltage, corresponding to a usage time of the display electroluminescent device. The compensation unit, including a compensation electroluminescent device, is couple to the driving node and drives the compensation electroluminescent device to illuminate in response to the driving voltage, so as to compensate the aging decay of the display electroluminescent device with the electroluminescent compensation unit.

This application claims the benefits of Taiwan application Serial No. 100115256, filed Apr. 29, 2011, and 100121494, filed Jun. 20, 2011, the subject matters of which are incorporated herein by reference.

### BACKGROUND OF THE INVENTION

1. Field of the Invention

The invention relates in general to an organic light emitting diode (OLED) pixel circuit, and more particularly to an OLED pixel circuit capable of compensating brightness deterioration which occurs due to long duration of use.

2. Description of the Related Art

With the rapid advance and continual progress in technology, the organic light emitting diode (OLED) technology has been provided and widely used in various applications such as TV, computer monitor, notebook computer, mobile phone or PDA. In general, the OLED display includes many OLED pixel circuits arranged in the form of a matrix, and each OLED pixel circuit includes an OLED element and a corresponding driving circuit.

In general, the OLED element and its driving circuit require a lasting conduction to perform image display operation. However, lasting conduction makes the threshold turn-on voltage of the OLED element increased and the display brightness deteriorated. Therefore, how to provide a compensation circuit capable of resolving the problems of increased threshold turn-on voltage and deteriorated display brightness which occur due to lasting usage of the OLED element has become a prominent task for the industries.

### SUMMARY OF THE INVENTION

According to one embodiment of the invention, an organic light emitting diode (OLED) pixel circuit is provided. The OLED pixel circuit includes an electroluminescent display device used in display operation and a pixel driving unit used for providing a driving voltage to drive the electroluminescent display device, wherein the level of the driving voltage is correlated with an aging factor voltage of the electroluminescent display device. Related OLED pixel circuit of the invention further includes an electroluminescent compensation unit including an electroluminescent compensation element, which drives the compensation electroluminescent display device to illuminate in response to the driving voltage, so as to compensate the aging decay of the electroluminescent display device with the electroluminescent compensation unit. In comparison to the conventional OLED display technology, related OLED pixel circuit of the invention has the advantage of compensating the aging factor voltage of an electroluminescent display device.

According to one embodiment of the invention, an organic light emitting diode (OLED) pixel circuit including a driving node, a pixel driving unit, an electroluminescent display device and an electroluminescent compensation unit is provided. The pixel driving unit is coupled to the data line for receiving a data voltage and providing a driving voltage to the driving node in response to the data voltage. The electroluminescent display device is coupled to the driving node for illuminating in response to the driving voltage, wherein the level of the driving voltage is correlated with an aging factor voltage of the electroluminescent display device and the aging factor voltage corresponds to a usage time of the electroluminescent display device. The electroluminescent compensation unit coupled to the driving node includes an electroluminescent compensation element and drives the compensation electroluminescent display device to illuminate in response to the driving voltage, so as to compensate the aging decay of the electroluminescent display device with the electroluminescent compensation unit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display using the OLED pixel circuit of the invention embodiment;

FIG. 2 shows a block diagram of an OLED pixel circuit P(i,j);

FIG. 3 shows a circuit diagram of an OLED pixel circuit according to a first embodiment of the invention;

FIG. 4 shows a circuit diagram of an OLED pixel circuit according to a second embodiment of the invention;

FIG. 5 shows a circuit diagram of an OLED pixel circuit according to a third embodiment of the invention;

FIG. 6 shows a circuit diagram of an OLED pixel circuit according to a fourth embodiment of the invention;

FIG. 7 shows a related signal timing diagram of the OLED pixel circuit of FIG. 6.

### DETAILED DESCRIPTION OF THE INVENTION

The organic light emitting diode (OLED) pixel circuit of one embodiment of the invention includes an electroluminescent display device used in display operation and a pixel driving unit used for providing a driving voltage which drives the electroluminescent display device, wherein the level of the driving voltage is correlated with an aging factor voltage of the electroluminescent display device. The OLED pixel circuit further includes an electroluminescent compensation unit which drives the compensation electroluminescent display device to illuminate in response to the driving voltage, so as to compensate the aging decay of the display electroluminescent device with the electroluminescent compensation unit

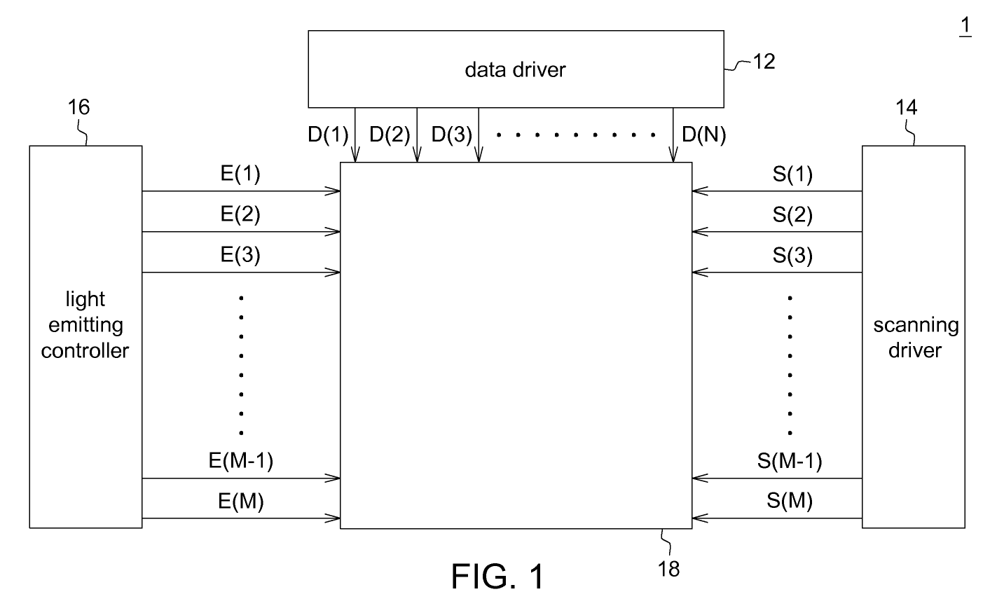

Referring to FIG. 1, a block diagram of a display using the OLED pixel circuit of the invention embodiment is shown. For example, the display 1 includes a data driver 12, a scanning driver 14, a light emitting controller 16 and a display panel 18. The display panel 18 includes a pixel matrix such as having M×N OLED pixel circuits P(1,1)˜P(M,N), wherein M and N both are a natural number larger than 1. The data driver 12, the scanning driver 14 and the light emitting controller 16 respectively provide data signals D(1)˜D(N), scanning signals S(1)˜S(M) and light emitting signals E(1)˜E(M) to the display panel 18 for driving each of the OLED pixel circuits P(1,1)˜P(M,N) to perform frame display operation.

Since the circuit structure and operations are substantially the same for each of the OLED pixel circuits P(1,1)˜P(M,N) of the display panel 18, only one OLED pixel circuit P(i,j) of the display panel 18 is exemplified for elaborating the circuit structure and operations of the OLED pixel circuits P(1,1)˜P(M,N) of the display panel 18, wherein i and j respectively are a natural number smaller than or equal to M and a natural number smaller than or equal to N.

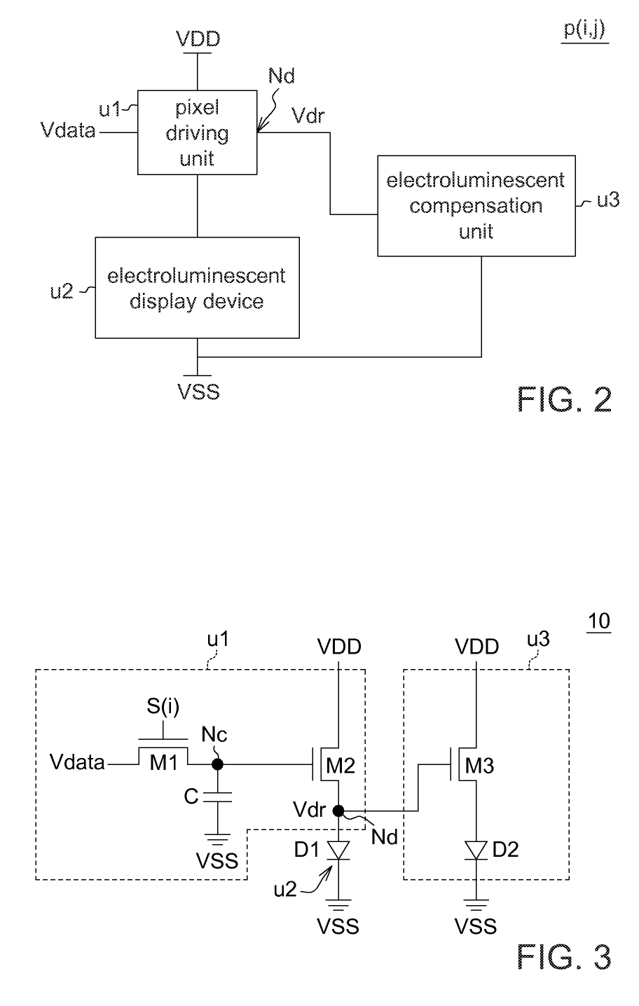

Referring to FIG. 2, a block diagram of an OLED pixel circuit P(i,j) is shown. The OLED pixel circuit P(i,j) includes a driving node Nd, a pixel driving unit u1, an electroluminescent display device u2 and an electroluminescent compensation unit u3. The pixel driving unit ul is coupled to the data line for receiving a data voltage Vdata and providing a driving voltage Vdr to the driving node Nd in response to the data voltage Vdata.

The electroluminescent display device u2 is coupled to the driving node Nd for illuminating in response to the driving voltage Vdr, wherein the electroluminescent display device u2 has an aging factor voltage Vaging, which correspondingly determines the level of the driving voltage Vdr. For example, the electroluminescent display device u2 is an OLED element, and the aging factor voltage Vaging is such as a threshold turn-on voltage of the OLED element. The threshold turn-on voltage of the OLED element increases along with lasting usage of the OLED element.

The electroluminescent compensation unit u3 is coupled to the driving node Nd, and includes an electroluminescent compensation element. The electroluminescent compensation unit u3 drives the electroluminescent compensation element to illuminate in response to the driving voltage Vdr, so as to compensate the aging decay of the electroluminescent display device u2 with the electroluminescent compensation unit u3. The electroluminescent compensation unit u3 further includes a compensation driving unit, which determines the auxiliary driving current in response to the driving voltage Vdr and drives the electroluminescent compensation element to illuminate.

Various operating examples of the OLED pixel circuit P(i,j) are disclosed below for elaborating each sub-unit of the OLED pixel circuit P(i,j).

### First Embodiment

Referring to FIG. 3, a detailed circuit diagram of an OLED pixel circuit according to a first embodiment of the invention is shown. In the OLED pixel circuit 10 of the present embodiment of the invention, the pixel driving unit u1, having a 2T1C circuit structure, includes a node Nc, transistors M1˜M2 and a capacitor C. The electroluminescent display device u2 includes an OLED element D1. The electroluminescent compensation unit u3 includes a transistor M3 and an OLED element D2, wherein the OLED element D2 realizes the electroluminescent compensation element, and the transistor M3 realizes the auxiliary driving unit.

Furthermore, the transistors M1˜M2 are such as N-type metal oxide semiconductor (MOS) transistors. Of the transistor M1, the gate receives a current-stage scanning signal S(i), the source is coupled to node Nc, and the drain is coupled to the data line for receiving a data voltage Vdata. Of the transistor M2, the gate is coupled to node Nc, the drain receives a high-potential reference voltage VDD, and the source is coupled to the driving node Nd. Of the capacitor, the first end is coupled to node Nc, and the second end receives a low-potential reference voltage VSS. Of the OLED element D1, the positive end and the negative end are respectively coupled to the driving node Nd and used for receiving a low-level reference voltage VSS.

The transistor M1 is turned on in a corresponding current-stage scanning period in response to the current-stage scanning signal S(i) to charge the capacitor C according to the data voltage Vdata. The transistor M2 is correspondingly turned on in response to the charging voltages of the two ends of the capacitor C for providing a driving current to drive the OLED element D1, wherein the driving voltage Vdr of the driving node Nd satisfies formula (1):

Vdr=Vth_D1 (1)

Wherein, Vth_D1 denotes the threshold turn-on voltage of the OLED element D1.

In an operating example, the threshold turn-on voltage Vth_D1 of the OLED element D1 is correspondingly increased along with the increase in the usage time, making the driving voltage Vdr increased correspondingly. For example, the threshold turn-on voltage Vth_D1 of the OLED element D1 is expressed as formula (2) below: Wherein, Vth_D1_initial denotes an initial threshold turn-on voltage before the OLED element D1 is under the stress effect, ΔV denotes a variation of the threshold turn-on voltage of the OLED element D1 under the stress effect, and the value of ΔV is positive correlated to the usage time of the OLED element D1.

Of the transistor M3 being an NMOS transistor, the gate receives a driving voltage Vdr, the source is coupled to the OLED element D2, and the drain receives a high-level reference voltage VDD. Of the OLED element D2, the positive end and the negative end are respectively coupled to the source of the transistor M3 and used for receiving a low-level reference voltage VSS. In other words, of the transistor M3, the gate and the source are respectively coupled to the positive ends of the OLED elements D1 and D2.

In an example, with special design of width/length ratio being applied to the transistor M3 and the OLED elements D1, the threshold turn-on voltage Vth_D1 of the OLED element D1, the threshold turn-on voltage Vth_D2 of the OLED element D2 and the threshold turn-on voltage Vth_M3 of the transistor M3 satisfy formula (3):

Vth_{—}D1_Initial−Vth_{—}D2≦Vth_{—}M3 (3)

Thus, before the OLED pixel circuit 10 is under the stress effect, the difference obtained by subtracting the threshold turn-on voltage of the OLED element D2 from a voltage across the OLED element D1 is smaller than or equal to the threshold turn-on voltage of the transistor M3. In other words, in the early stage of the use of the OLED pixel circuit 10, the voltage across the OLED element D1 is not sufficient to turn on the transistor M3, so the OLED element D2 is turned off and does not illuminate. In an operating example, the threshold turn-on voltage Vth_M3 of the transistor M3 is 2V, but the threshold turn-on voltages of the OLED elements D1 and D2 are equal to 2V and 3V respectively.

After the OLED pixel circuit 10 has been used for a period Tu (such as 10000 hours), the brightness of the OLED element D1 decays due to lasting conduction. Meanwhile, the threshold turn-on voltage Vth_D1 of the OLED element D1 is also increased under the stress effect, making the driving voltage Vdr increased as well. The driving voltage Vdr(Tu) is expressed as formula (4) below:

Vdr(Tu)=Vth_{—}D1(Tu)=Vth_{—}D1_initial+ΔV(Tu) (4)

Wherein, ΔV(Tu) denotes a variation obtained by subtracting the initial threshold turn-on voltage Vth_D1_initial of the OLED element D1 from the threshold turn-on voltage Vth_D1 after the period Tu. Meanwhile, the driving voltage Vdr(Tu) satisfies formula (5):

Vth_{—}D1(Tu)−Vth_{—}D2=Vth_{—}D1_initial+ΔV(Tu)−Vth_{—}D2>Vth_{—}M3 (5)

In other words, the OLED element D1 ages due to the stress effect, making the impedance of the OLED element D1 increased, the current flowing through the OLED element D1 decreased, and the display brightness of the OLED pixel circuit 10 deteriorated. Meanwhile, the threshold turn-on voltage Vth_D1 of the OLED element D1 also generates a variation ΔV(Tu) due to the stress effect, making the difference between the two threshold turn-on voltages Vth_D1 and Vth_D2 higher than the threshold turn-on voltage Vth_M35 of the transistor M3, such that the transistor M3 is turned on and the OLED element D2 used as an electroluminescent compensation element illuminates. Thus, the OLED pixel circuit 10 of the present embodiment of the invention compensates the brightness decay of the OLED element D1 (used as an electroluminescent display device u2) with the turned-on OLED element D2 (used as an electroluminescent compensation element).

In addition, the threshold turn-on voltage Vth_D1 increases with the increase in the duration of stress influence, making the difference between the threshold turn-on voltages Vth_D1 and Vth_D2 increased correspondingly, such that the transistor M3 provides a larger current for driving the OLED element D2. In other words, the brightness of the OLED element D2 used as an electroluminescent compensation element is positively proportional to the duration of display operation and the aging factor voltage, that is, the threshold turn-on voltage Vth_D1 of the OLED element D1.

### Second Embodiment

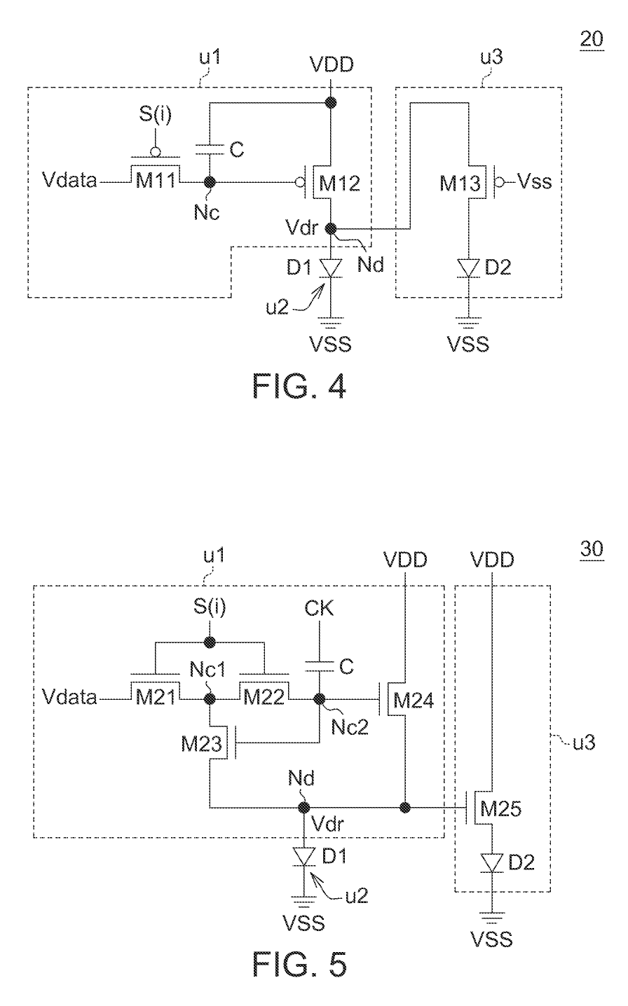

Referring to FIG. 4, a circuit diagram of an OLED pixel circuit according to a second embodiment of the invention is shown. The OLED pixel circuit 20 of the present embodiment of the invention is different from the OLED pixel circuit 10 of the first embodiment in that the manufacturing of the transistors adopts the LTPS process, such that all the transistors are P-type MOS transistors.

Let the electroluminescent compensation unit u3 be taken for example. Of the transistor M13, the gate receives a low-potential reference voltage VSS, and the drain is coupled to the positive end of the OLED element D2. Of the OLED element D2, the negative end is coupled to a terminal end which receives a low-level reference voltage VSS. Of the transistor M13, the source is coupled to the driving node Nd for receiving a driving voltage Vdr. Before the OLED pixel circuit 20 is under the stress effect, the positive end voltage of the OLED element D1 is used a power supply for the electroluminescent compensation unit u3. Since the gate of the transistor M13 is grounded, the voltage VGS_M13 across gate-source ends of the transistor M13 is negative and makes the transistor M13 turned on. For example, the voltage VGS_M13 of the transistor M13 satisfies formula (6):

VGS_{—}M1VSS−Vth_{—}D1_initial<0 (6)

After the OLED pixel circuit 20 displays for a period Tu, the cross-voltage between the positive end and the negative end of the OLED element D1 increases due to element aging, such that the voltage level of the positive end of the OLED element D1 also increases correspondingly. Thus, the voltage level of the voltage VGS_M13 of the transistor M13 becomes even negative, making the current flowing through the transistor M13 increased, and the OLED element D2 used as an electroluminescent compensation element illuminate with even larger brightness, so as to compensate the brightness decay of the OLED element D1 used as an electroluminescent display device u2.

### Third Embodiment

Referring to FIG. 5, a circuit diagram of an OLED pixel circuit according to a third embodiment of the invention is shown. The OLED pixel circuit 30 of the present embodiment of the invention is different from the OLED pixel circuit 10 of the first embodiment in that the pixel driving unit u1 has a different circuit structure. Furthermore, the pixel driving unit u1 of the present embodiment of the invention includes nodes Nc1 and Nc2, transistors M21˜M25 and a capacitor C, wherein transistors M21˜M25 are such as NMOS transistors.

Of the transistor M21, the gate receives a current-stage scanning signal S(i), the drain is coupled to the data line for receiving a data voltage Vdata, and the source is coupled to the node Nc1. Of the transistor M22, the gate receives a current-stage scanning signal S(i), the drain is coupled to node Nc1, and the source is coupled to node Nc2. Of the transistor M23, the gate is coupled to node Nc2, the drain is coupled to node Nc1, and the source is coupled to the driving node Nd. Of the transistor M24, the gate is coupled to the node Nc2, the drain receives a high-potential reference voltage VDD, and the source is coupled to the driving node Nd. Of the capacitor C, the first end and the second end are respectively coupled to the node Nc2 and used for receiving a pulse signal CK.

For example, the transistor M22 is turned on for connecting the gate and the drain of the transistor M23 together, such that the transistor M23 is biased into diode connection configuration and coupled between the transistor M21 and the OLED element D1. The transistors M21 and M23 and the OLED element D1 further form a voltage divider-circuit for dividing the data voltage Vdata and making the driving voltage Vdr of the driving node Nd substantially become a voltage divider component of the data voltage Vdata. For example, the driving voltage Vdr and the data voltage Vdata satisfy formula (7):

$$Vdr = Vdata \frac{Z\_D 1}{Z\_M 21 + Z\_M 23 + Z\_D 1} \qquad ( 7 )$$

Wherein, Z_D1, Z_M21 and M_M23 respectively are an equivalent resistance of the OLED element D1 and the transistors M21 and M23.

Thus, when the OLED element D1 is under the stress effect and correspondingly has a higher threshold turn-on voltage Vth_D1, the resistance Z_D1 of the OLED element D1 also increases correspondingly. As indicated in formula (7), the driving voltage Vdr correspondingly has an increased variation due to the increase in the resistance Z_D1. To summarize, the pixel driving unit u1 correspondingly provides a higher driving voltage Vdr in response to the increased threshold turn-on voltage Vth_D1 of the OLED element D1, so as to compensate the variation of the threshold turn-on voltage Vth_D1 of the OLED element D1.

The OLED pixel circuit 30 of the present embodiment of the invention correspondingly includes an electroluminescent compensation unit u3 realized by such as a transistor M25 and an OLED element D2. The electroluminescent compensation unit u3 correspondingly illuminates in response to the driving voltage Vdr, so as to compensate the brightness decay which is generated due to lasting usage of the OLED element D1. The principles of operations of the electroluminescent compensation unit u3 of the present embodiment of the invention are the same with that of the electroluminescent compensation unit u3 of the first embodiment, and the similarities are not repeated here.

In addition, the OLED pixel circuit 30 of the present embodiment of the invention further receives a pulse signal CK with the second end of the capacitor C. In an operating example, when the transistors M21 and M22 are turned on in the current-stage scanning period in response to the current-stage scanning signal S(i), the pulse signal CK corresponds to a low-level reference voltage VSS. Since the data voltage Vdata is written to the node Nc2 via the transistors M21 and M22, the node Nc2 corresponds to an operating voltage Vdata′, and the first end of the capacitor C, in comparison to the second end, correspondingly stores the voltage Vdata′-VSS.

After the display operation of the OLED element D1 is completed, the OLED pixel circuit 30 of the present embodiment of the invention provides a negative-potential voltage for driving the transistor M24 so as to mitigate the turned-on stress effect which occurs due to lasting conduction of the transistor M24. Furthermore, after the display operation of the OLED element D1 is completed, the pulse signal CK is switched to a negative-potential reference voltage Vmin from a low-potential reference voltage VSS. Thus, the voltage level of the first end of the capacitor C drops to the operating voltage Vdata′+Vmin due to the coupling effect between the two ends of the capacitor C. For example, the absolute value of the operating voltage Vdata′ is substantially smaller than the absolute value of the negative-potential reference voltage Vmin, such that the operating voltage Vdata′+Vmin substantially corresponds to a negative-potential lower than the low-potential reference voltage VSS. Thus, after the current-stage scanning period, the first end of the capacitor C correspondingly provides a negative-potential voltage for driving the transistor M24 so as to mitigate the turned-on stress effect which occurs due to lasting conduction of the transistor M24.

### Fourth Embodiment

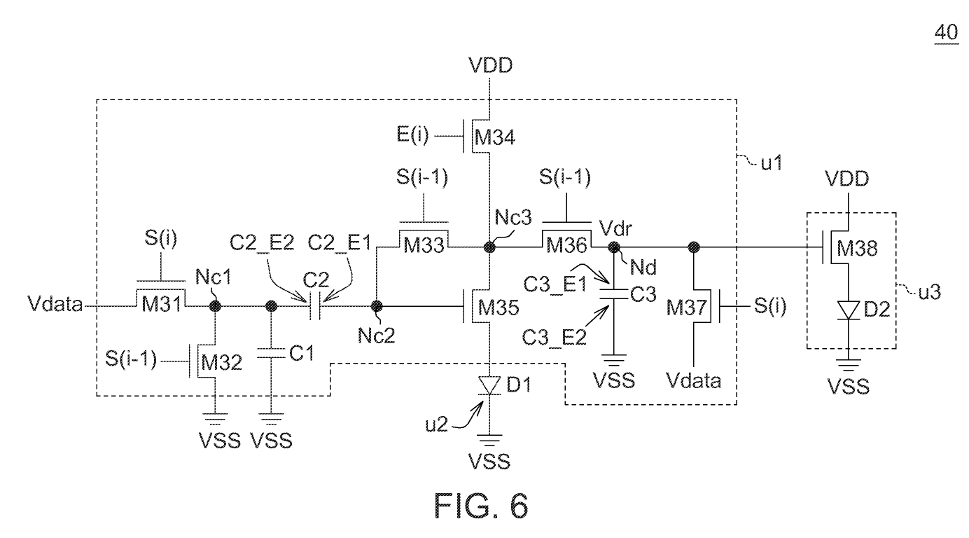

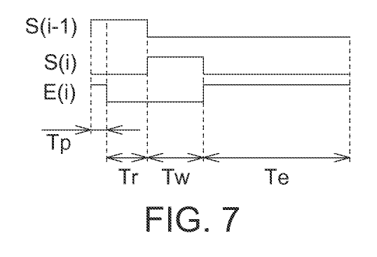

Referring to FIGS. 6 and 7. FIG. 6 shows a circuit diagram of an OLED pixel circuit according to a fourth embodiment of the invention. FIG. 7 shows a time sequence about the circuit operations of FIG. 6, including a pre-charging period Tp, a pre-writing period Tr, a writing period Tw and a display period Te.

The OLED pixel circuit 40 of the present embodiment of the invention is different from the OLED pixel circuit 10 of the first embodiment in that the pixel driving unit u1 has a different circuit structure. Furthermore, the pixel driving unit u1 of the present embodiment of the invention includes nodes Nc1 and Nc2, transistors M31˜M37 and capacitors C1˜C3, and the electroluminescent compensation unit u3 includes a transistor M38 and an OLED element D2, wherein transistor M31˜M38 are such as NMOS transistors.

The gates of the transistors M32, M33 and M36 receive a previous-stage scanning signal S(i-1). The source of the transistor M32 receives a low-potential reference voltage VSS, the source of the transistor M33 is coupled to the node Nc2 and the source of the transistor M36 is coupled to the driving node Nd. The drain of the transistor M32 is coupled to node Nc1, and the drains of the transistors M33 and M36 are coupled to the node Nc3. The transistor M32, M33 and M36 are turned on in the pre-charging period Tp and the pre-writing period Tr in response to a previous-stage scanning signal S(i-1) but are turned off in other operating periods.

Of the transistors M31 and M37, the gates receive a current-stage scanning signal S(i), the drains receive a data voltage Vdata, and the sources are respectively coupled to the node Nc1 and the driving node Nd. The transistors M31 and M37 are turned on in the writing period Tw in response to the current-stage scanning signal S(i) but are turned off in other operating periods.

Of the transistor M34, the gate receives a current-stage light emitting signal E(i), the drain receives a high-potential reference voltage VDD, and the source is coupled to node Nc3. The transistor M34 is turned on in the pre-charging period Tp and the display period Te in response to the current-stage light emitting signal E(i) but is turned off in other operating periods.

Of the transistor M35, the gate is coupled to node Nc2, the drain is coupled to node Nc3, and the source is coupled to the electroluminescent display device u2. Of the capacitor C1, the two ends are respectively coupled to the node Nc1 and used for receiving a low-potential reference voltage VSS. Of the capacitor C2, the first end C2_E1 and the second end C2_E2 are respectively coupled to the nodes Nc2 and Nc1. Of the capacitor C3, the first end C3_E1 and the second end C3_E2 are respectively coupled to the driving node Nd and used for receiving a low-potential reference voltage VSS.

Of the transistor M38, the gate receives a driving voltage Vdr, the source is coupled to the OLED element D2, and the drain receives a high-level reference voltage VDD. Of the OLED element D2, the positive end and the negative end are respectively coupled to the source of the transistor M38 and used for receiving a low-level reference voltage VSS.

Referring to FIG. 7. In the pre-charging period Tp, the previous-stage scanning signal S(i-1) and the current-stage light emitting signal E(i) are enabled but the current-stage scanning signal S(i) is disabled. Thus, the transistors M32, M33, M34, M35 and M36 are turned on but the transistors M31 and M37 are turned off, such that the first end C2_E1 of capacitor C2, in comparison to the second end C2_E2, has a pre-charging voltage Vpre, and the first end C3_E1 of the capacitor C, in comparison to the second end C3_E2, also has a pre-charging voltage Vpre. For example, the pre-charging voltage Vpre satisfies formula (8):

Vpre=VDD−VSS=VDD (8)

In the pre-writing period Tr, the previous-stage scanning signal S(i-1) is enabled but the current-stage light emitting signal E(i) and the current-stage scanning signal S(i) are disabled. Thus, the transistors M32, M33, M35 and M36 are turned on but the transistors M31, M34 and M37 are turned off, wherein the turned-on transistor M33 are shorted to connect the gate and the drain of the transistor M35 together, such that the transistor M35 is biased into diode configuration. Therefore, the voltage of the two ends of the capacitor C2 is discharged to the threshold voltage Vth1 via a path including the transistor M35 and the OLED element D1, and the voltage of the two ends of the capacitor C3 is discharged to the threshold voltage Vth2 via a path including the transistors M35 and M36 and the OLED element D1, wherein the threshold voltage Vth1 and Vth2 satisfy formula (9):

Vth1=Vth2=Vth_{—}M35+Vth_{—}D1 (9)

Wherein, Vth_M35 and Vth_D1 are a threshold turn-on voltage for the transistor M35 and the OLED element D1 respectively. In other words, the capacitors C2 and C3 record the sum of the threshold turn-on voltages of the transistor M35 and the OLED element D1.

In the data writing period Tw, the current-stage scanning signal S(i) is enabled but the previous-stage scanning signal S(i-1) and the current-stage light emitting signal E(i) are disabled. Thus, the transistors M31 and M37 are turned on but the transistors M32˜M36 are turned off, such that the two ends of the capacitor C1 are charged to the data voltage Vdata, the two ends of the capacitor C2 store the threshold voltage Vth1, and the voltage Vth2′ of the two ends of the capacitor C3 satisfies formula (10) in response to the transistor M37 being turned on.

Vth2′=Vth_{—}M35+Vth_{—}D1−Vdischarge (10)

Wherein, the discharging voltage Vdischarge is correlated with the level of the data voltage Vdata. In greater details, the transistor M37 has a high on-state resistance Ron, and the discharging rate of the discharging voltage Vdischarge is determined according to the high on-state resistance Ron when the transistor M37 is turned on. Thus, under different levels of data voltages Vdata, different degrees of compensation are performed on the decay of the OLED element D1. In other words, the transistor M37 provides the data voltage Vdata to the driving node Nd in the data writing period Tw, such that the driving voltage Vdr of the driving node Nd follows the level of the data voltage Vdata. Thus, when the data voltage Vdata corresponds to different voltage levels, the data voltage Vdata is provided to the driving node Nd for performing different degrees of compensation on the characteristics decay of the OLED element D1 which occurs due to increased threshold turn-on voltage.

In the driving period Te, the current-stage scanning signals S(i) and the previous-stage scanning signals S(i-1) are disabled but the current-stage light emitting signal E(i) is enabled. Thus, the transistors M34 and M35 are turned on but the transistors M31˜M33 and M36˜M37 are turned off for applying the voltage across the first end C2_E1 of the capacitor C2 and the second end C1_E2 of the capacitor C1, that is the sum of the threshold voltage Vth1 and the data voltage Vdata, to the gate-source of the transistor M35 and the OLED element D2. As indicated in formula (9), the gate-source voltage Vgs_M35 of the transistor M35 satisfies formula (11):

$$\begin{matrix}Vgs\_M 35 = Vth 1 + Vdata - Vth\_D 1 \\ = Vth\_M 35 + Vth\_D1 + Vdata - Vth\_D1 \\ = Vth\_M35 + Vdata\end{matrix} \qquad ( 11 )$$

Since the gate-source voltage Vgs_M35 of the transistor M35 is expressed as formula (11), the source current I flowing through the transistor M35 is the driving current flowing through the OLED unit D1, and satisfies formula (12):

$$\begin{matrix}I = {k ( Vgs\_M35 - Vth\_M35 )}^{2} \\ = {k [ ( Vth\_M35 + Vdata ) - Vth\_M35 ]}^{2} \\ = {k [ Vdata ]}^{2}\end{matrix} \qquad ( 12 )$$

As indicated in formula (12), the current flowing through the OLED element D1 is not affected by the threshold turn-on voltage Vth_M35 of the transistor M35 and the threshold turn-on voltage Vth_D1 of the OLED element D1. Therefore, despite the threshold turn-on voltage Vth_M35 of the transistor M35 and the threshold turn-on voltage Vth_D1 of the OLED element D1 increase due to the stress effect, the magnitude of the driving current I is still not affected and is only correlated with the data voltage Vdata. In other words, the OLED pixel circuit 40 of the present embodiment of the invention correspondingly compensates the variation of the threshold turn-on voltages driving the transistor M35 and the OLED element D1.

In addition, the OLED pixel circuit 40 of the present embodiment of the invention also has an electroluminescent compensation unit u3 for compensating the brightness decay of the electroluminescent display device u2. In the OLED pixel circuit 40 of the present embodiment of the invention, the driving voltage Vdr of the driving node Nd is correlated with the threshold turn-on voltages Vth_M35 and Vth_D1 of the transistor M35 and the OLED element D1. When the threshold turn-on voltages Vth_M35 and Vth_D1 of the transistor M35 and the OLED element D1 increase due to the stress effect, the driving voltage Vdr corresponds to a higher voltage level. Thus, the transistor M38 of the electroluminescent compensation unit u3 correspondingly provides a larger driving current for driving the OLED element D2 in response to a driving voltage Vdr having a higher voltage level (referring to formula (10)). In other words, the OLED element D2 correspondingly adjusts the brightness according to the variation of the threshold turn-on voltages Vth_M35 and Vth_D1 of the OLED element D1 and the transistor M35. The larger the variation of the threshold turn-on voltages Vth_M35 and Vth_D1, the higher the level of the driving voltage Vdr, and the larger the current driving the OLED element D2.

The OLED pixel circuit disclosed in above embodiments of the invention includes an electroluminescent display device used in display operation and a pixel driving unit used for providing a driving voltage to drive the electroluminescent display device, wherein the level of the driving voltage is correlated with an aging factor voltage of the electroluminescent display device. In the above embodiments of the invention, the OLED pixel circuit further includes an electroluminescent compensation unit including an electroluminescent compensation element, which drives the compensation electroluminescent display device to illuminate in response to the driving voltage, so as to compensate the aging decay of the electroluminescent display device with the electroluminescent compensation unit. In comparison to the conventional OLED display technology, the OLED pixel circuit disclosed in above embodiments of the invention has the advantage of compensating the aging factor voltage of an electroluminescent display device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel circuit of an electroluminescent display, comprising:
a driving node;
a pixel driving unit coupled to a data line for receiving a data voltage and providing a driving voltage to the driving node in response to the data voltage;
an electroluminescent display device coupled to the driving node for illuminating in response to the driving voltage, wherein the level of the driving voltage is correlated with an aging factor voltage of the electroluminescent display device, and the aging factor voltage corresponds to a usage time of the electroluminescent display device; and
an electroluminescent compensation unit coupled to the driving node, wherein the electroluminescent compensation unit comprises an electroluminescent compensation element, which drives the compensation electroluminescent display device to illuminate in response to the driving voltage, so as to compensate the aging decay of the electroluminescent display device with the electroluminescent compensation unit.

2. The pixel circuit according to claim 1, wherein the electroluminescent compensation unit comprises:
an auxiliary driving unit coupled to the driving node for determining an auxiliary driving current in response to the driving voltage, and accordingly driving the electroluminescent compensation element to illuminate.

3. The pixel circuit according to claim 2, wherein the auxiliary driving unit comprises:
a transistor having a gate coupled to the driving node for receiving a driving voltage, a drain receiving a high-potential reference voltage, and a source coupled to the electroluminescent compensation element.

4. The pixel unit according to claim 3, wherein the electroluminescent compensation element comprises:
an organic light emitting diode (OLED) having positive end coupled to the source of the transistor, and a negative end receiving a low-potential reference voltage.

5. The OLED pixel unit according to claim 2, wherein the auxiliary driving unit comprises:
a transistor having a source coupled to the driving node for receiving a driving voltage, a drain coupled to the electroluminescent compensation element, and a gate receiving a low-potential reference voltage.

6. The OLED pixel unit according to claim 5, wherein the electroluminescent compensation element comprises:
an OLED having a positive end coupled to the drain of the transistor, and a negative end receiving the low-potential reference voltage.

7. The pixel unit according to claim 1, wherein the electroluminescent display device comprises:
an OLED having a positive end coupled to the driving node for receiving a driving voltage and a negative end receiving a low-potential reference voltage.

8. The pixel unit according to claim 1, wherein the pixel driving unit comprises:
a node;
a first transistor having a gate receiving a current-stage scanning signal, a source coupled to the node, and a drain coupled to the data line for receiving a data voltage;
a second transistor having a gate coupled to the node, a drain receiving a high-potential reference voltage, and a source coupled to the driving node; and
a capacitor having a first end coupled to the node and a second end receiving a low-potential reference voltage.

9. The pixel unit according to claim 1, wherein the pixel driving unit comprises:
a node;
a first transistor having a gate receiving a current-stage scanning signal, a drain coupled to the node, and a source coupled to the data line for receiving a data voltage;
a second transistor having a gate is coupled to the node, a drain coupled to the driving node, and a source receiving a high-potential reference voltage; and
a capacitor having a first end coupled to the node, and a second end receives the high-potential reference voltage.

10. The pixel unit according to claim 1, wherein the pixel driving unit comprises:
a first node and a second node;
a first transistor having a gate receives a current-stage scanning signal, a drain coupled to the data line for receiving a data voltage, and a source coupled to the first node;
a second transistor having a gate receiving the current-stage scanning signal, a drain coupled to the first node, and a source coupled to the second node;
a third transistor having a gate coupled to the second node, a drain coupled to the first node, and a source coupled to the driving node;
a fourth transistor having a gate coupled to the second node, a drain receiving a high-potential reference voltage, and a source coupled to the driving node; and
a capacitor having a first end and a second end respectively coupled to the second node and receive a pulse signal.

11. The pixel unit according to claim 1, wherein the pixel driving unit comprises:
a first node, a second node and a third node;
a first transistor having a gate receiving a previous-stage scanning signal, a drain coupled to the first node, and a source receiving a low-potential reference voltage;
a second transistor having a gate receiving the previous-stage scanning signal, a drain coupled to the third node, and a source coupled to the second node;
a third transistor having a gate receiving the previous-stage scanning signal, a drain coupled to the third node, and a source coupled to the driving node;
a fourth transistor having a gate receiving a current-stage scanning signal, a drain receiving the data voltage, and a source coupled to the first node;
a fifth transistor having a gate receiving the current-stage scanning signal, a drain receiving the data voltage, and a source coupled to the driving node;
a sixth transistor having a gate receiving a current-stage light emitting signal, a drain receiving the high-potential reference voltage, and a source coupled to the third node;
a seventh transistor having a gate coupled to the second node, a drain coupled to the third node, and a source coupled to the electroluminescent display device;
a first capacitor having two ends respectively coupled to the first node and receiving the low-potential reference voltage;
a second capacitor having two ends respectively coupled to the first and the second node; and
a third capacitor having two ends respectively coupled to the driving node and receiving the low-potential reference voltage.
